(19) United States
(12) Patent Application Publication
(10) Pub. No.: US 2006/0028032 A1
(43) Pub. Date: Feb. 9, 2006

(54) Vehicle bumper and method of making same

(76) Inventor: Karl Henseleit, Jonesville, MI (US)

Correspondence Address: BURGESS LAW OFFICE, PLLC, P. O. BOX 214320, AUBURN HILLS, MI, 48321-4320, US

(21) Appl. No.: 10/913,867

(22) Filed: Aug. 6, 2004

(51) Int. Cl. B60R 19/04

(52) U.S. Cl. 293/102

(57) ABSTRACT

Accordingly, the present invention is a vehicle bumper and a method for making a vehicle bumper formed from first and second members wherein the second member is nested within the first member. Each of the first and second members has a front wall, an upper wall and a lower wall. Each member also includes flange portions extending outwardly from the respective upper and lower walls. The first and second members joined to one another at their respective front walls and flange portions. The first and second members formed in such a way that the cross-sections of the members varies along the longitudinal axis of the vehicle bumper. Varying the respective cross-sections enables a vehicle bumper design that helps to control energy transfer and absorption during a collision. In addition, it provides greater design and styling freedoms.

### BACKGROUND OF THE INVENTION

1. Field of the Invention

The present invention relates generally to a vehicle bumper and, more particularly, to a bumper having inner and outer structural members combined to form the bumper.

2. Description of Related Art

A bumper is attached typically to the front and rear end of a motor vehicle to absorb shock and to protect the passengers during a collision. The bumper is typically coupled to the vehicle frame and should be strong enough to withstand and absorb damage from a low impact collision. Being able to withstand a low impact collision reduces the need to repair or replace the bumper, along with other body parts, vehicle components or structure, as a result of a minor impact.

In addition, the bumper should have a shape and structural design such that during a collision it helps to absorb and distribute the energy resulting from the collision and to transmit the energy to the vehicle frame. Modern vehicles traditionally demand an aerodynamic design. Accordingly, it is preferable that the bumper also have an aerodynamic shape which reduces wind resistance and adds to the aesthetics or visual appeal of the vehicle.

In the past, bumpers were manufactured using a roll form process wherein the cross-section is formed by passing a sheet stock material through a plurality of rollers. Such a roll form process is limiting in that many of today's modern aerodynamic bumper shapes cannot be roll formed. Further, it is impractical to change the cross-sections, shape and design configuration of the bumper over the length of the bumper. Finally, roll forming is of limited use when forming many of the high strength steels used in today's bumper designs.

### SUMMARY OF THE INVENTION

Accordingly, the present invention is a vehicle bumper and a method for making a vehicle bumper having first and second members, wherein the second member is nested within the first member. The first member having a front wall, an upper wall and a lower wall. The upper and lower walls having outwardly extending flanges. The second member having a front wall, an upper wall and a lower wall. The upper and lower walls of the second member also having outwardly extending flanges. The first and second members are connected to one another at their respective front walls and flanges.

In one embodiment, the cross-sectional shape of the first and second members varies along the length of the respective members. For instance, depending upon the location on the bumper, the length of the respective upper and lower walls may be longer or shorter. In addition, the front wall of the first member may include an indentation in the center thereof extending rearward toward the second member.

In accordance with a further embodiment, a plurality of deformation elements may be formed in the upper or lower walls of the respective first and second members to provide a path and/or area that deforms to absorb energy resulting from an impact load. Thus, the configuration of the inner and outer members, along with placement of deformation elements provides a vehicle bumper having a shape and structural design which helps to absorb and distribute energy resulting from a collision while being able to withstand a low impact collision without the need to repair or replace the bumper and other body parts, vehicle components or structure, as a result of a minor impact.

Further, the present invention provides a method for forming a vehicle bumper wherein first and second blanks of high strength steel are placed in various forming dies and formed into respective first and second members. The first and second members join together to form the vehicle bumper. The respective cross-sections of each of the first and second members differing from one another, whereby when the first and second members join together to form the vehicle bumper only a portion of the first member contacts the second member.

In addition, the first and second members can be formed in a plurality of configurations, including curved along or about the longitudinal axis thereof, typically by using a plurality of forming dies. Forming the first and second members in this way, typically by stamping, enables the first and second members to be formed in a plurality of shapes and configurations which otherwise are not attainable through a roll forming process.

### BRIEF DESCRIPTION OF THE DRAWINGS

FIG. 1 is a perspective view of a vehicle bumper according to the present invention.

FIG. 2 is an exploded perspective view of the vehicle bumper according to the present invention shown in FIG. 1.

FIG. 3 is a top view of the vehicle bumper according to the present invention shown in FIG. 1.

FIG. 4 is a cross-sectional view of the vehicle bumper according to the present invention shown in FIG. 1 taken along the lines 44.

FIG. 5 is a cross-sectional view of the vehicle bumper according to the present invention shown in FIG. 1 taken along the lines 5-5.

FIG. 6 is a cross-sectional view of the vehicle bumper according to the present invention shown in FIG. 1 taken along the lines 6-6.

FIG. 7 is a partial perspective view of an alternative embodiment of a vehicle bumper according to the present invention.

FIG. 8 is a partial top view of the vehicle bumper according to the alternative embodiment of the present invention shown in FIG. 7.

FIG. 9 is a cross-sectional view of the vehicle bumper according to the alternative embodiment of the present invention shown in FIG. 8 taken along the lines 9-9.

FIG. 10 is a cross-sectional view of the vehicle bumper according to the alternative embodiment of the present invention shown in FIG. 8 taken along the lines 10-10.

### DETAILED DESCRIPTION OF THE INVENTION

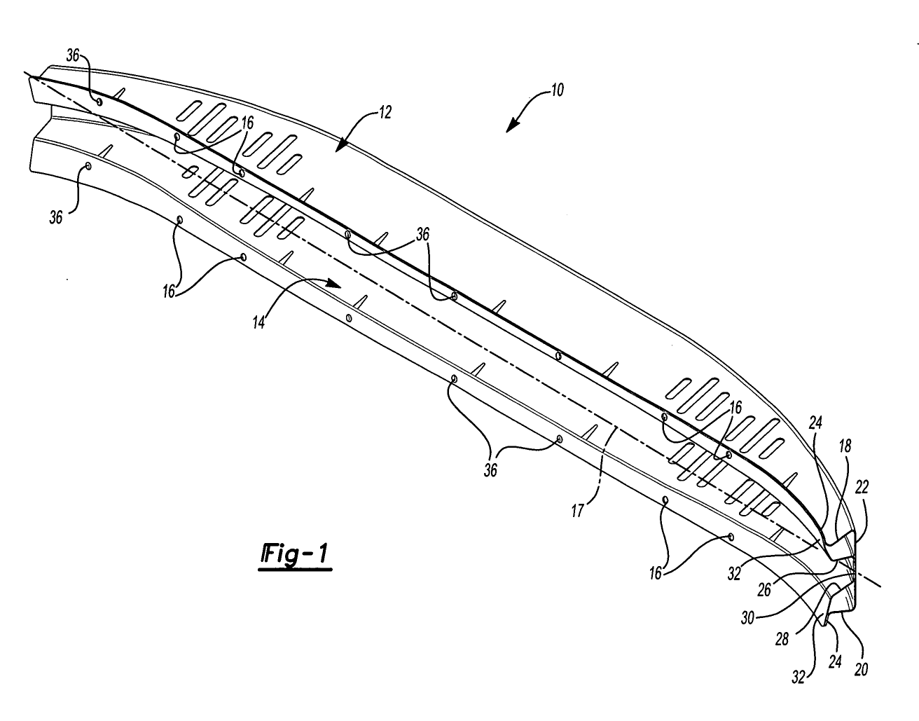

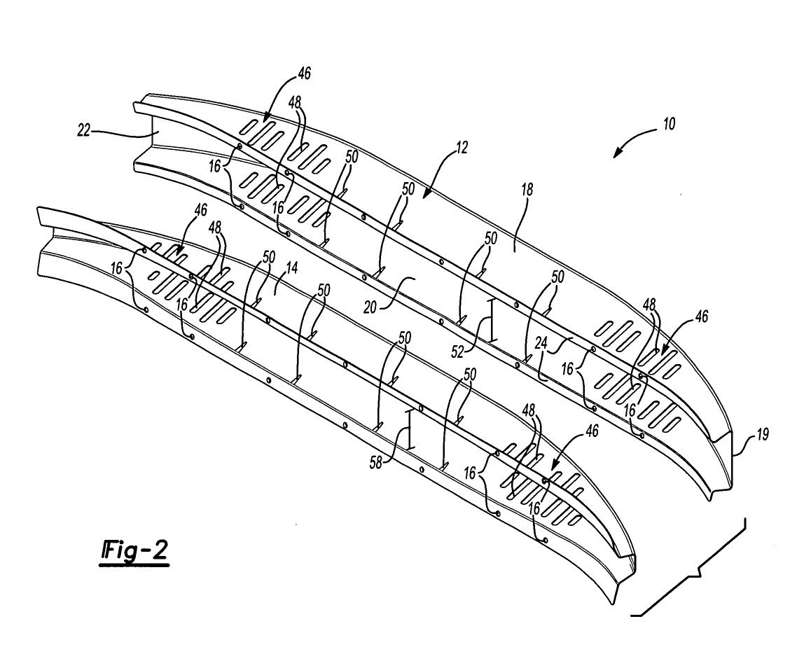

FIGS. 1 and 2 illustrate a vehicle bumper, seen generally at 10, according to one embodiment of the present invention. The vehicle bumper includes a first or outer member 12 and a second or inner member 14. As shown, the second or inner member 14 fits within the first or outer member 12 in a nested relationship. The vehicle bumper 10 includes a plurality of mounting holes 16 used to secure the bumper 10 to a vehicle frame (not shown.) In accordance with known mounting methods, other mounting plates, braces or supports may be used to secure the vehicle bumper 10 to the vehicle frame. In addition, it should be understood that a bumper cover (not shown) is typically secured to or placed over the vehicle bumper 10.

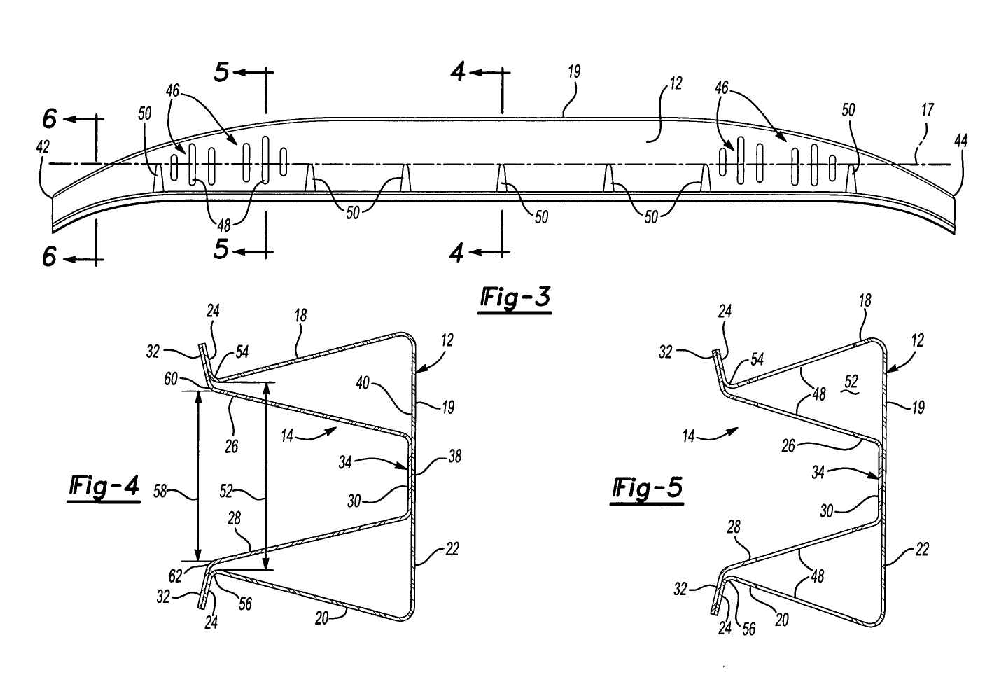

As shown in FIG. 1, the vehicle bumper 10 extends longitudinally along a longitudinal axis 17. In the present embodiment, the vehicle bumper 10 has a swept configuration. Swept is a term used in conjunction with vehicle bumpers to indicate the curvature of the bumper. As shown in FIG. 3, the front face 19 of the vehicle bumper 10 curves rearwardly, with respect to its longitudinal axis 17, toward the vehicle. The degree or amount of curvature and the specific location thereof being variable and subject to particular vehicle needs and designs. In addition, vehicle requirements or standards may require the vehicle bumper 10 to withstand impact with minor deformation at low speeds, for example five miles per hour. Accordingly, the vehicle bumper 10 is manufactured from a material suitable to withstand impact at such low speeds. In the preferred embodiment, the vehicle bumper 10 is manufactured from 140 k.s.i. high strength steel.

As illustrated in FIG. 2, the first or outer member 12 has a generally u-shaped cross-section formed from an upper wall 18, a lower wall 20 and a front wall 22. The front wall 22 interconnects the upper wall 18 with the lower wall 20. In addition, the front wall 22 of the first or outer member 12 has an exterior surface which forms the front face 19 of the vehicle bumper 10. The first or outer member 12 further includes outwardly extending flange members 24 located on both the upper wall 18 and the lower wall 20.

The second or inner member 14 has a generally v-shaped cross-section formed of an upper wall 26, a lower wall 28 and a front wall 30. The front wall 30 forms the base or apex 34 of the generally v-shaped cross-section. As with the first or outer member 12, the front wall 30 of the second or inner member 14 interconnects the upper wall 26 with the lower wall 28. The second or inner member 14 further includes outwardly extending flange members 32.

Pursuant to the present invention, the second or inner member 14 fits within the first or outer member 12 in a nested relationship wherein at least the respective flange members 24 of the first or outer member 12 contact the flange members 32 of the second or inner member 14. As shown in FIG. 1, the respective flange members 24, 32, and thus the corresponding first and second members 12, 14, are welded together at various weld points 36 extending longitudinally along the respective flange members 24, 32. The weld points 36 are typically formed using a spot weld procedure; however, other types of welds and connectors could also be used.

In the preferred embodiment, a front surface 38 of the front wall 30 of the second or inner member 14 contacts a rear surface 40 of the front wall 22 of the first or outer member 12. Moreover, the respective front walls 22, 30 of the first and second members 12, 14 are also welded together at various weld points extending longitudinally along the front walls 22, 30 of the first and second members 12, 14.

In addition, deformation elements, seen generally at 46, may be formed in various areas of the vehicle bumper 10 as needed to absorb and redirect energy resulting from an impact. These deformation elements 46 may include holes or slots 48 formed in the upper and lower walls 18, 20 of the first or outer member 12 and the upper and lower walls 26, 28 of the second or inner member 14. While the holes or slots 48 are shown located near the mounting holes 16 on the vehicle bumper 10, this is according to one embodiment of the invention. It is contemplated that the deformation elements 46, including the slots 48, may be located wherever necessary to control the deflection and correspondingly transfer energy resulting from an impact load.

The vehicle bumper 10 further includes indentations 50, often referred to as take up beads. These indentations 50 occur when forming the first or outer member 12 and second or inner member 14 of the vehicle bumper 10 through a stamping or pressure forming process. As set forth more fully herein, stamping or pressure forming the first and second members 12, 14 of the vehicle bumper 10 provides a method by which the shape and configuration of the vehicle bumper 10 can be adjusted to meet loading and aesthetic design requirements.

As shown in FIGS. 3-6, the configuration of the vehicle bumper 10 changes at various points along its longitudinal axis 17 between first and second ends 42, 44 of the vehicle bumper 10. Specifically, a vehicle bumper 10, formed according to the present invention, may have a plurality of different shaped cross-sections; see FIGS. 4-6, occurring along various points or regions of the vehicle bumper 10. Accordingly, the vehicle bumper 10 can be configured to transfer energy resulting from an impact, typically resulting when a vehicle collides with another object, often another vehicle, from the vehicle bumper 10 to the vehicle frame.

As shown in FIGS. 3-6, the upper and lower walls 18, 20 of the first or outer member 12 slope inwardly toward one another, whereby the open area or gap 52 between the respective ends 54, 56 of the upper and lower walls 18, 20 of the first or outer member 12 is less than the length of the front wall 22 connected to the opposite ends of the upper and lower walls 18, 20. In addition, the upper and lower walls 26, 28 of the second or inner member 14 slope outwardly away from one another, such that the open area or gap 58 between the respective ends 60, 62 of the upper and lower walls 26, 28 of the second or inner member 14 is greater than the length of the front wall 30 connected to the opposite ends of the upper and lower walls 26, 28. It should be understood that the slope of the upper and lower walls, and correspondingly the angle between the upper and lower walls and the front wall of the respective first and second members 12, 14, may vary depending upon particular vehicle bumper 10 impact requirements.

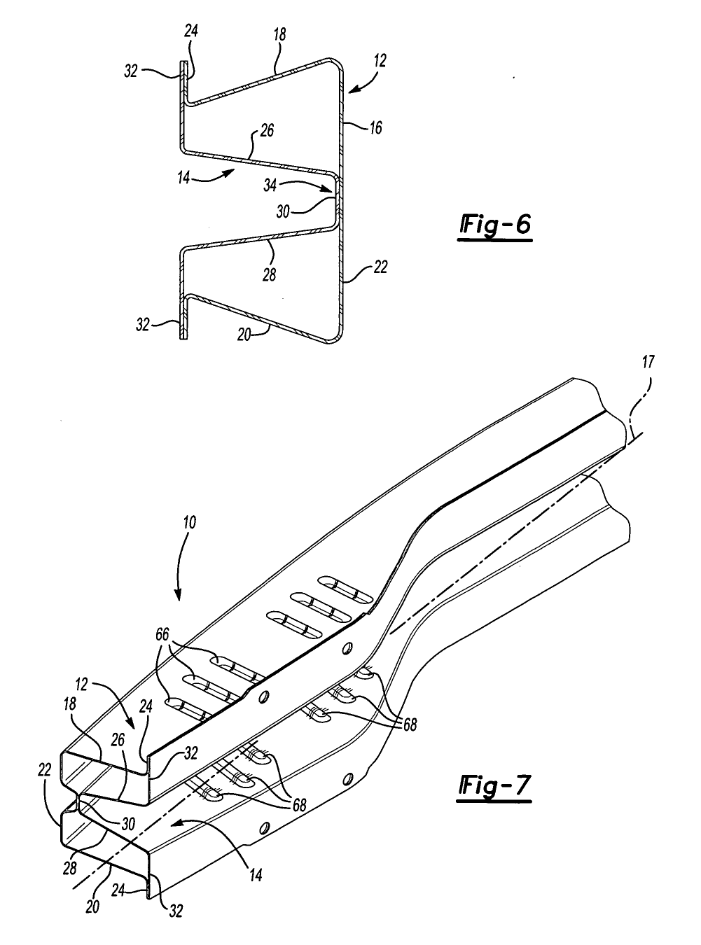

Turning now to FIG. 6, there is shown a cross-section of the vehicle bumper 10 taken near the end 42 of the vehicle bumper 10. As illustrated, the overall width or lateral thickness 63 of the vehicle bumper 10 decreases near the ends 42, 44 of the vehicle bumper 10. In addition, the length of the flange 32 of the second or inner member 14 is increased, whereby the distance 58 between the respective ends 60, 62 of the upper and lower walls 26, 28 is decreased. Accordingly, varying the length of the respective flange members 32 and the opening or gap 58 further provides an additional variable for controlling deformation of the vehicle bumper 10 during an impact and correspondingly provides another mechanism to transfer and absorb impact energy.

Turning now to FIGS. 6-10, there is shown a second embodiment of the present invention. Again, the vehicle bumper 10 includes a first or outer member 12 and a second or inner member 14 placed together in a nested relationship. As set forth above, the first or outer member 12 includes an upper wall 18, a lower wall 20 and a front wall 22 interconnecting the upper wall 18 with the lower wall 20. The second or inner member 14 includes an upper wall 26, a lower wall 28 and a front wall 30 interconnecting the upper wall 26 with the lower wall 28.

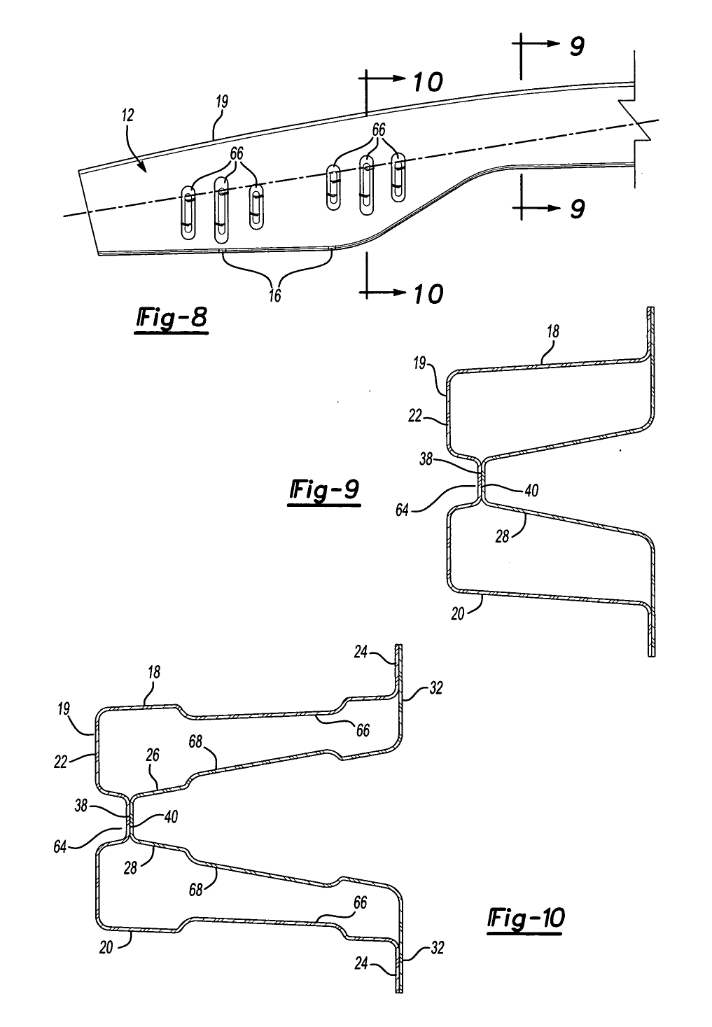

As shown in FIGS. 8-10, the shape and corresponding cross-section of the vehicle bumper 10 varies depending upon the position along the longitudinal axis 17. For instance, as shown in FIG. 8, the lateral width of the vehicle bumper 10 is less than the previous embodiment and increases in the area of the mounting holes 16 used to secure the vehicle bumper 10 to the vehicle. Thus, the vehicle bumper 10 is formed of a complex configuration wherein the shape and configuration, including the sweep or curvature of the vehicle bumper 10, changes along its longitudinal axis 17.

As shown in FIGS. 9-10, the vehicle bumper 10 according to the alternative embodiment, includes a groove or indentation 64 formed in the front wall 22 of the first or outer member 12. The groove or indentation 64 extends rearwardly from the front wall 22 toward the front wall 30 of the second or inner member 14. The front surface 38 of the front wall 30 of the inner member 14 contacts the rear surface 40 of the front face 19 of the outer member 12. It should be understood that the size or width of the groove or indentation 64 is approximately that of the width of the front wall 30 of the second or inner member 14 forming the base or apex 34 of the v-shaped second or inner member 14.

In accordance with one aspect of the invention, the depth of the indentation 64 affects the energy absorption characteristics of the vehicle bumper 10. Specifically, deepening the indentation 64 increases the energy absorption characteristics of the vehicle bumper 10 yet it decreases its resistance to deformation. While maximum resistance to deformation may be obtained by removing the indentation 64, which strengthens the vehicle bumper 10, it reduces deformation characteristics and will correspondingly transmit more energy to the vehicle. It has been found that an indentation 64 roughly equal to double the thickness of the material, in this case the high-strength steel used to form the vehicle bumper, results in a fair balance of deformation resistance and energy absorption.

As shown in FIG. 10, the deformation elements 46 are formed by indentations or depressions 66 formed in the upper and lower walls 18, 20 of the first or outer member 12 and projections or raised portions 68 formed in the upper and lower walls 26, 28 of the second or inner member 14. While shown with the indentation 66 formed in the first or outer member 12 and the projections 68 formed in the second or inner member 14, these positions could be reversed with the indentations 66 being formed in the second or inner member 14 in the projections 68 formed in the first or outer member 12. It should be understood that, like the holes or slots 48 set forth in the previous embodiment, the indentations 66 and projections 68 function to provide a energy transfer path whereby impact energy from a collision or impact load placed on the vehicle bumper 10 may be absorbed and transferred to the vehicle, in particular the vehicle frame.

Accordingly, the present invention discloses a unique structure of a two-piece vehicle bumper 10. Wherein the particular configuration of the first or outer member 12 and the second or inner member 14 is variable to provide a lightweight bumper formed of high-strength steel. It should be appreciated that forming the second or inner member 14 with a generally v-shaped cross-section softens impact and allows for easier buckling and thus increases energy absorption and dissipation of impact forces. Further, providing an indentation 64 and the front wall 22 of the first or outer member 12 helps to stabilize the first or outer member 12 and enable the vehicle bumper 10 to absorb energy in the center portion, not just the two mounting points.

In addition, the present invention further contemplates a method for forming a vehicle bumper 10 as set forth above. In particular, the first and second members 12, 14 are formed from blanks of flat, high-strength steel sheet stock. The blanks are placed in first and second forming dies. The first forming die having a configuration suitable to form the first member 12 and the second forming die having a configuration suitable to form the second member 14. It should be understood that the first and second forming dies may be the type having upper and lower die members mounted in a forming or stamping press. Further, it may be necessary to put the blank through several forming or stamping steps to ultimately form the first or outer member 12 and the second or inner member 14.

Press forming or stamping the first or outer member 12 and the second or inner member 14 from a 140 k.s.i. high-strength steel blank provides a method whereby complex and multiple configurations or cross-sections can be formed in a single member, such as the first or second members 12 and 14, that cannot be formed using a standard roll forming process. Accordingly, the present method enables the production of a bumper member or component having a cross-section which can be varied along the longitudinal axis 17 of the vehicle bumper 10 to control the energy transfer path. Further, press forming or stamping the v-shaped section of the second or inner member 14 helps to stabilize the chevron pattern and prevent the high-strength steel from springing back.

Further, as shown in FIG. 2, the width of the flanges 32 of the inner member 14 are greater at the ends 42, 44 of the vehicle bumper 10 than in the middle. The greater the width of the flanges 32 the smaller the gap or opening 68 between the ends 60, 62 of the upper and lower walls 26, 28. As the gap 68 continues to grow smaller eventually the upper and lower walls 26, 28 will extend perpendicular to the front wall 30. The closer the upper and lower walls 26, 28 of the second or inner member 14 are to perpendicular, the more resistance provided by the inner member 14 as the v-shape softens impact and buckles or deforms easier. Thus, press forming or stamping the second or inner member 14 enables the width of the flanges 32 and correspondingly the width of the gap or opening 68, to vary along the longitudinal axis 17 of the vehicle bumper 10.

It will be realized, however, that the foregoing specific embodiments have been shown and described for the purposes of illustrating the functional and structural principles of the invention and is subject to change without departure from such principles. Therefore, this invention includes all modifications encompassed within the scope of the following claims.

What is claimed is:

1. A vehicle bumper comprising:
first and second members, said second member nested within said first member;
said first member extending longitudinally between first and second ends and having a cross-section including a front wall, an upper wall and a lower wall, said upper and lower walls including outwardly extending flange portions;
said second member extending longitudinally between first and second ends and having a cross-section including a front wall, an upper wall and a lower wall, said upper and lower walls having flange portions; and
said second member nested within said first member such that said front wall of said second member contacts said front wall of said first member and said flange members of said first and second members contact one another; and
at least a portion of said first and second members curved with respect to a longitudinal axis of said first and second members.

2. A vehicle bumper as set forth in claim 1 wherein the length of said upper and lower walls is reduced at the first and second ends of said first and second members.

3. A vehicle bumper as set forth in claim 1 wherein said upper and lower walls of said first member combine with said front wall of said first member to form a channel, said flange members located at and extending outward at an open end of said channel wherein the distance between the respective upper and lower walls at the open end of said channel is less than the overall length of the front wall of said first outer member.

4. A vehicle bumper as set forth in claim 1 wherein said upper and lower walls of said second member combine with said front wall of said second member to form a channel, said flange members located at and extending outward at an open end of said channel wherein the distance between the upper and lower walls of said second member at the open end of said channel is greater than the length of the front wall of the second member.

5. A vehicle bumper as set forth in claim 1 wherein the respective upper and lower walls of said first member extend rearward from said front wall in a direction skewed with respect to the plane of said front wall.

6. A vehicle bumper as set forth in claim 1 wherein said second member is welded to said first member at said flange portions.

7. A vehicle bumper as set forth in claim 1 wherein said cross-sections of said first and second members varies between said first and second ends of said first and second members.

8. A vehicle bumper as set forth in claim 7 wherein said cross-sections of said first and second members include a plurality of configurations designed to control energy transfer.

9. A vehicle bumper as set forth in claim 1 wherein said first and second members are made of 140 k.s.i. high-strength steel.

10. A vehicle bumper as set forth in claim 1 wherein at least one of said first and second members includes deformation elements located in said upper and lower walls of said first and second members.

11. A vehicle bumper as set forth in claim 1 including an inwardly extending indentation formed in said front wall of said first member.

12. A vehicle bumper as set forth in claim 1 wherein said first member has at least one region having a generally w-shaped cross-section and said second member has at least one region having a generally v-shaped cross-section;
said second member nested within said first member such that an apex of said v-shaped cross-section of said second member contacts an apex of the generally w-shaped cross-section of said first member.

13. A vehicle bumper as set forth in claim 12 wherein said upper and lower walls of at least one of said first and second members are nonlinear.

14. A vehicle bumper as set forth in claim 12 having a plurality of cross-section configurations taken along a longitudinal length of said first and second members.

15. A vehicle bumper as set forth in claim 12 wherein the length of said respective upper and lower walls of said first and second members is greater at the center of said first and second members than at the respective ends of said first and second members.

16. A vehicle bumper as set forth in claim 12 including at least one deformation element formed in at least one of said first and second members.

17. A vehicle bumper comprising:
an outer member, said outer member extending longitudinally between first and second ends, said outer member including a front wall, an upper wall and a lower wall, an indentation formed in said front wall wherein said front wall, said upper wall and said lower wall cooperate to define, in at least one region of said outer member, a generally w-shaped cross-section;
an inner member, said inner member extending longitudinally between first and second ends, said inner member including a front wall, an upper wall and a lower wall wherein said front wall, said upper wall and said lower wall cooperate to define, in at least one region of said inner member, a generally v-shaped cross-section;
said inner member nested within said outer member such that the apex of the generally v-shaped cross-section of said inner member contacts the apex of the center portion of said generally w-shaped cross-section of said outer member.

18. A vehicle bumper as set forth in claim 17 including at least one deformation element formed in at least one of said first and second members.

19. A vehicle bumper as set forth in claim 17 wherein said upper and lower walls of said inner member combine with said front wall of said inner member to form a channel, said inner member further including flange members located at and extending outward at an open end of said channel of said inner member wherein the distance between the upper and lower walls of said inner member at said open end of said channel of said inner member is greater than the length of the front wall of said inner member.

20. A vehicle bumper as set forth in claim 17 wherein said cross-sectional shape of said inner and outer members varies between said first and second ends of said inner and outer members, such that the length of said upper and lower walls of said inner and outer members decreases adjacent said first and second ends of said inner and outer members.

21. A vehicle bumper as set forth in claim 17 including:
said upper and lower walls of said inner member combine with said front wall of said inner member to form a channel, said inner member further including flange members located at and extending outward at an open end of said channel of said inner member wherein the distance between the upper and lower walls of said inner member at said open end of said channel of said inner member is greater than the length of the front wall of said inner member;
a deformation element formed in at least one of said upper and lower walls of said inner and outer members;
said cross-sectional shapes of said inner and outer members variable such that the length of said upper and lower walls of said inner and outer members is reduced at the first and second ends of said inner and outer members.

22. A vehicle bumper as set forth in claim 21 wherein said deformation element includes a plurality of take up beads located in said upper and lower walls of said inner and outer members.

23. A vehicle bumper as set forth in claim 21 wherein said deformation element includes a plurality of indentations located in said upper and lower walls of said inner and outer members.

24. A vehicle bumper as set forth in claim 21 wherein said inner and outer members are connected to one another at said apexes of said respective cross-sections and at said respective flange members.

25. A vehicle bumper as set forth in claim 21 wherein said first and second members are made of 140 k.s.i. high-strength steel.

26. A method of making a vehicle bumper comprising the steps of:
providing first and second members of high-strength steel;
placing the first member in a least one forming die and using the forming die to form the first member;
placing the second member in a second forming die and using the second forming die to form the second member, the second member formed in a shape including at least a portion thereof having a cross-section different from a cross-section of the first member; and
joining the first and second members together to form the bumper.

27. A method for forming a bumper according to claim 26 wherein the first and second members of high-strength steel are made of steel having a yield strength greater than 100 k.s.i.

28. A method for forming a bumper according to claim 26 wherein the step of using the first forming die to form the first member includes forming the first member with a plurality of cross-sections, each of the cross-sections extending transverse the longitudinal axis of the bumper.

29. A method for forming a bumper according to claim 26 wherein the step of using the first forming die to form the first member includes using a plurality of forming dies to form the first member.

30. A method for forming a bumper according to claim 26 wherein the step of using the second forming die to form the second member includes forming the second member with a plurality of cross-sections, each of the cross-sections extending transverse the longitudinal axis of the bumper.

31. A method for forming a bumper according to claim 30 including the step of using the forming die to form the first member with a plurality of indentations in the first member.

32. A method for forming a bumper according to claim 26 wherein the steps of forming said bumper includes the step of forming the first member with an upper and a lower wall connected by a front wall, each of the upper and lower walls having outwardly extending flange members formed thereon;
forming the second member with an upper and a lower wall connected by a front wall, each of said upper and lower walls having outwardly extending flange members formed thereon, the second member configured such that it fits between the upper and lower walls of the first member; and
the step of joining includes placing the second member between the upper and lower walls of the first member wherein at least a portion of the front wall of the second member contacts at least a portion of the front wall of the first member and at least portions of the respective flanges of the first and second members contact one another.

33. A method for forming a bumper according to claim 32 including the steps of forming the first member with a w-shaped cross-section and forming the second member with a v-shaped cross-section;
placing the second member in the first member in a nested relationship such that the front wall of the second member forming the base of the v-shaped cross-section contacts the front wall of the first member forming the center projection of the w-shaped cross-section; and
placing the respective flange members of the first and second member in contact with one another.

34. A method for forming a bumper according to claim 33 including forming at least one of the first and second members with a cross-section that varies along the longitudinal axis of said at least one of said first and second members.

35. A method for forming a bumper according to claim 26 including forming a plurality of indentations in the upper and lower walls of at least one of said first and second members.
